(19) United States
(12) Patent Application Publication
(10) Pub. No.: US 2007/0224374 A1
(43) Pub. Date: Sep. 27, 2007

(54) Lightweight article and method of manufacture

(75) Inventor: Paul Kelley, Wrightsville, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: Graham Packaging Company, LP, York, PA (US)

(21) Appl. No.: 11/385,834

(22) Filed: Mar. 22, 2006

(51) Int. Cl. B32B 27/08

(52) U.S. Cl. 428/35.7

(57) ABSTRACT

The present invention is directed to a method of manufacturing an article, the method comprising providing a tubular body having a neck area, positioning a finish mold on the neck area in a molding apparatus, molding a molten plastic material between the neck area of the tubular body and the finish mold, allowing the molten plastic material to solidify, and removing the finish mold.

### BACKGROUND OF THE INVENTION

1. Field of the Invention

The present invention relates generally to an article of manufacture, and more specifically to an article comprising a finish molded over the neck of a tubular body, such as a preform body or a container body.

2. Description of Related Art

A commonly experienced problem in the art of molding preforms is that the neck area/finish is often improperly formed when plastic is injected at the bottom of the preform. Hoop and axial stretch ratios are also compromised, as prior art methods require that the neck of the preform and the preform body have the same thickness. This results in the need to alter the height or diameter of the preform body so that the body of the preform will have the desired thickness.

Another limitation of current methods of preform manufacturing is that the body of the preform may need to be thicker than desired, in order to obtain the desired neck finish that can withstand subsequent fill temperatures. The thickness of the preform body adds to the weight of the container.

One solution currently available in the art as disclosed in published U.S. Patent Application No. 2005/0218103 A1 is a process where a neck ring (finish) is first molded, placed in a preform assembly manufacturing apparatus, and a preform body is subsequently molded inside the finish. Another proposed solution, as disclosed in published U.S. Patent Application No. 2004/0166263 A1, involves separately manufacturing each of a preform and a neck ring, then assembling the two pieces. A further solution, disclosed in published U.S. Patent Application No. 2004/0146673 A1, discloses manufacturing a preform and a split annular ring, then placing the ring over the preform. Yet another solution, disclosed in published U.S. Patent Application No. 2004/166264 A1, is directed to a process for blow molding a container from a preform and mechanically attaching a separately molded neck finish over the container.

Most of these prior art solutions require the extra step of separately manufacturing each of a preform and a neck ring or finish. Mechanical attachment of the neck ring to a container or preform body can be tedious, and result in an imperfect fit and a flawed container. Thus, there is a need in the art for an efficient method of producing a lightweight preform with neck finish suitable for hot fill and pasteurization processes that does not require excess steps or added components.

### BRIEF SUMMARY OF THE INVENTION

The present invention is directed to manufacturing an article such as a lightweight preform. The method includes providing a tubular body having a neck area, placing a finish mold on the neck area in a molding apparatus, molding hot plastic material between the neck area of the tubular body and the finish mold, allowing the plastic to solidify, and removing the finish mold.

In one embodiment of the invention, the molding apparatus can be an an injection molding apparatus and the tubular body can be mounted onto the injection molding apparatus. The tubular body can be a preform body, and the tubular body can also be a container.

Molding of the neck finish can accomplished by injection or compression blow molding. The method can include injection molding the preform body and/or blow molding a container. The finish mold can include a thread split.

The present invention is also directed to a method of manufacturing an article by providing a molded tubular body having a neck area and molding a finish over the neck area. The tubular body and the finish can be made from different materials. The finish can be made from polyethylene terapthalate, polypropylene, polyethylene, polyethylene napthalate, process regrind, post consumer resin, or combinations thereof, and the tubular body can be made from polyethylene terapthalate, polyethylene terapthalate and ethylene vinyl alcohol, or polyethylene terapthalate and nylon. The tubular body can be partly or entirely multilayered, and can be an injection or compression molded preform body. The finish can also be injection or compression molded. The method can additionally include the step of compression blow molding the preform body.

The present invention is further directed to an article comprising a tubular body and a finish, where the finish is molded over the neck area of the tubular body subsequent to molding of the preform body. The article can be a container or a preform.

Further objectives and advantages, as well as the structure and function of the preferred embodiments, will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts a top view of a preform body according to one embodiment of the present invention;

FIG. 2 illustrates a cross section of the preform body of FIG. 1 taken along line 2-2 of FIG. 1;

FIG. 3 depicts a top view of a neck finish according to one embodiment of the present invention;

FIG. 4 illustrates a cross section of the neck finish of FIG. 3 taken along line 4-4 of FIG. 1;

FIG. 5 depicts a side view of a preform and neck finish according to one embodiment of the present invention; and

FIG. 6 depicts a cross section of a preform and neck finish according to one embodiment of the present invention.

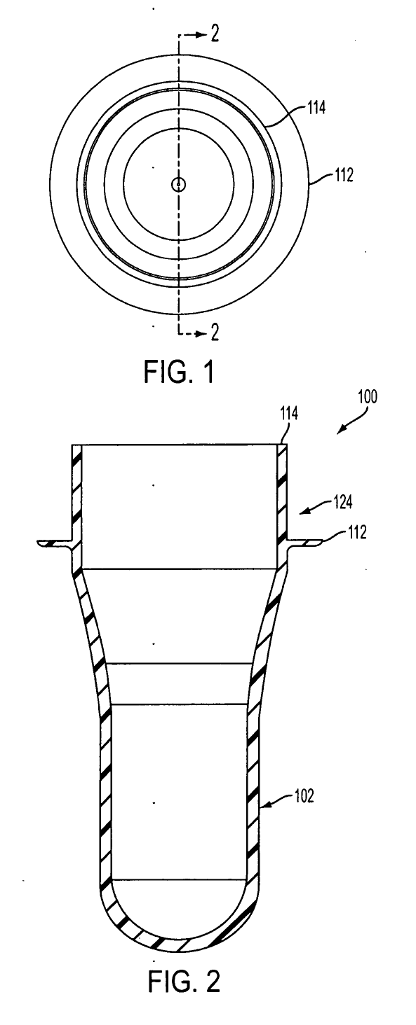

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

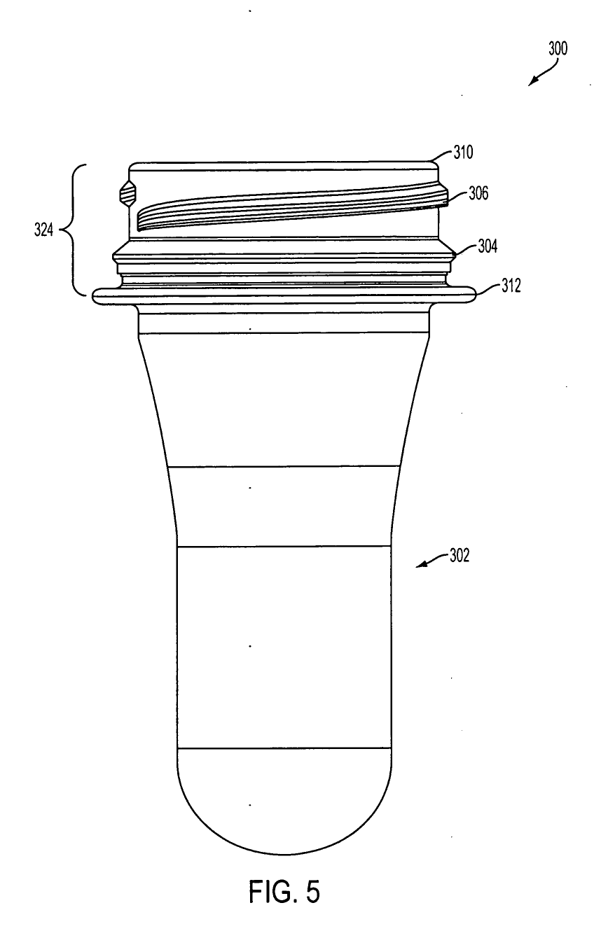

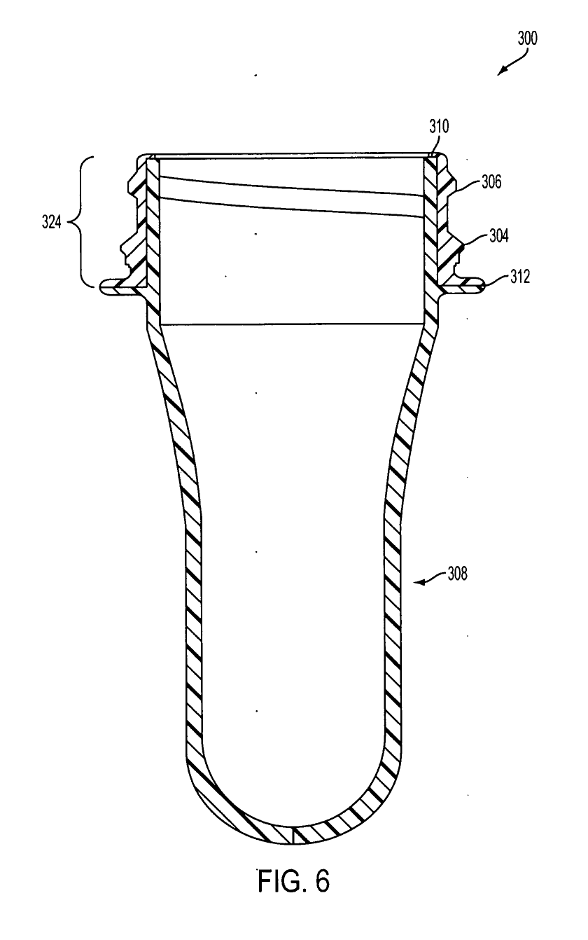

The present invention is directed to a method of manufacturing an article such as the article illustrated in FIGS. 5 and 6. The method includes providing a tubular body. The tubular body can be, for example, a container body or a preform body. The illustrated embodiments include a preform body 100, but it should be understood that the invention is not so limited.

As shown in FIG. 2, preform body 100 has a bottom portion 102 and neck area 124. Preform body 100 also has an end surface 114 at the top of the preform body 100 and a flange 112 spaced apart from the top. Neck area 124 terminates at the end surface 114.

Preform body 100 can be made from, for example, polyethylene terapthalate, polyethylene terapthalate and ethylene vinyl alcohol, or polyethylene terapthalate and nylon. Preform body 100 can be formed of a single layer that includes one or more such material or can be multilayered. The present method can additionally include the step of molding the preform body 100 by, for example, injection molding. Thus, the invention encompasses the manufacturing of an article by using a previously formed preform body 100, as well as molding the preform body 100 as part of the process of manufacturing the article.

The step of providing a tubular body can include mounting the preform body 100 a molding apparatus. The method of the invention further involves positioning a mold for forming a finish 200 on the neck area 124 in a molding apparatus (not shown). For purposes of illustration, the finish 200 is shown apart from the preform body 100. However, as will be apparent to persons skilled in the art, the neck finish 200 is molded onto the preform body 100 and is not manufactured as a separate article. The mold part for forming the neck finish 200 can include a thread split for forming thread 206, but an alternate component, such as a mold portion for bayonet-type mechanism is also possible. Persons skilled in the art will recognize molds that can be used or modified for use in the present invention.

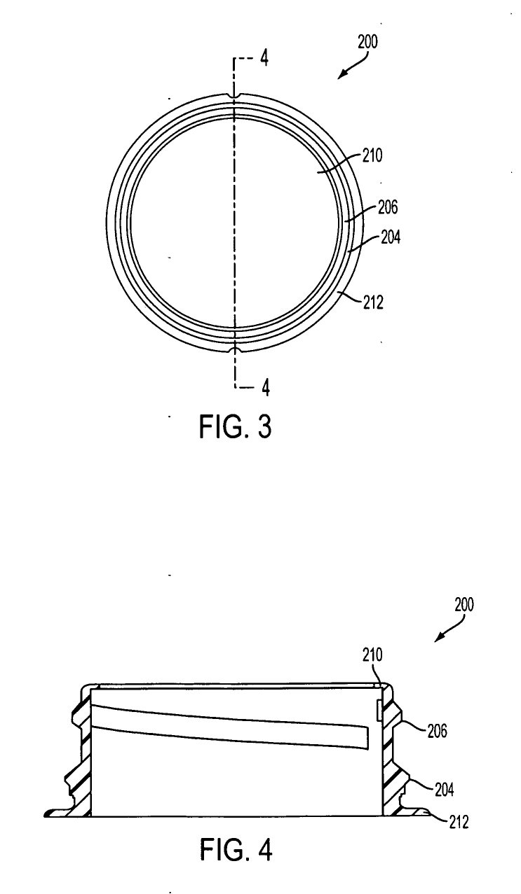

FIGS. 3 and 4 illustrate a neck finish 200 that can be formed from the finish mold as discussed above, by, for example, injection molding. The neck finish 200 can be molded over the neck area 124 of preform body 100 to create a finished article. FIGS. 5 and 6 illustrate an article according to the present invention. The neck finish 200 can include one or more of the following features: flange 212, tamper bead 204, thread 206, and lip 210. Lip 210 can engage end surface 114 of a tubular body and can also provide a softer, curved surface for drinking in embodiments where the article is a container, or, when the article is a preform, a container molded from the preform.

After the finish mold is placed over the neck area 124 of preform body 100, molten plastic material is introduced to the finish mold and the neck finish 324 is molded (see FIGS. 5 and 6). Molding can be accomplished by, for example, injection or compression molding. The molten plastic is allowed to solidify, and then the finish mold is removed to provide an article that includes the preform body 100 and finished neck 324. The neck finish 324 can be made from, for example, polyethylene terapthalate, polypropylene, polyethylene, polyethylene napthalate, process regrind, post consumer resin, or combinations thereof. Because the neck finish 324 is molded in a separate step than preform body 100, the neck finish 324 can be made from different materials than the preform body 100.

FIGS. 5 and 6 illustrate side and cross-sectional views, respectively, of a finished article of the invention. In the illustrated embodiment, the article is a preform 300. The preform 300 has a bottom portion 302, which corresponds to the bottom portion 102 of preform body 100, and a neck finish 324, molded over the neck area 124 of preform body 100. Flange 312 of the preform 300 is formed from both the flange 112 of preform body 100 and the flange 212 of neck finish 200. Alternatively, flange 312 can be formed exclusively by flange 112 or 212. Tamper bead 304 and threads 306 present on exterior surface of the finished preform 300 are formed from the tamper bead 204 and threads 208 of neck finish 200. The top of the surface of the preform 300 includes a sealing surface 310 for contact with a cap (not shown) in an end product, such as a container. In the illustrated embodiment, sealing surface 310 of preform 300 is formed by the overlap of the lip 210 of the finish 200 on the end surface 114 of the preform body 100. Alternatively, the finish 200 can be manufactured without a lip 210, resulting in a sealing surface 310 formed from the end of the finish 200 and the end surface 114 of the preform body 110. The end of the finish 200 is the portion furthest away from preform body 100.

The method of present invention also includes blow molding a container. For example, after the neck finish 200 is molded onto the tubular body, the mold is removed, and a container blow molded from the bottom portion 302 of the preform 300. Alternatively, a container body can be molded from preform body 100 prior to the molding of the finish, and then the neck finish 200 can be molded over the neck area 124 of the container. That is, the tubular body is a container body on which neck finish 200 is molded. The resulting container can be suitable for, for example, hot-fill and pasteurization processes.

Though the method as outlined above describes molding of neck finish after molding of the tubular body, the present invention also allows molding of the neck finish in a molding apparatus and subsequent molding of the tubular body. For example, neck finish 200 can first be molded in a molding apparatus, and then preform body 100 can be injection molded in the same apparatus.

The method of present invention is advantageous in that the separate molding of the neck finish allows greater control during the manufacturing process. In particular, when a finish and a body are molded together in a single step, for example by injection molding, more molten plastic may need to be injected in the mold to provide sufficient material to fill in the finish portion of the mold. This method results in a preform body that is thicker and heavier than necessary or desired and can lead to underpacking—a defect where an inadequate amount of plastic reaches the finish portion of the mold. This one-step process of manufacture also requires that the body portion and the finish portion be of a similar thickness. The one-step method is particularly disadvantageous when forming a preform or container for use in hot fill or pasteurization processes in which the neck finish must be thicker in order to withstand hot fill and pasteurization. The result of this one-step method is that the body of the manufactured article is often thicker than desired. In contrast, the method of the present invention allows independent manufacture of the neck finish. Therefore, neck finish having an increased thickness can be manufactured without an undesirable increase in body thickness.

Manufacture of a neck finish and a tubular body in separate steps in accordance with the present invention is desirable in that it allows the production of a neck finish and tubular body each having different materials. This can be advantageous when, for example, it is necessary to include more expensive barrier or multilayered materials in the body, but such materials are not required throughout the entire thickness of the finish. For example, less expensive, post consumer (recycled) material can be used in the neck, while the body is made using virgin material. In contrast, when a sturdier neck finish is required, more expensive materials can be used in the finish, without having to incur the additional cost of manufacturing the body using the same materials. This is particularly advantageous, for example, when the neck is required to withstand hot-fill processing, or forces from caps such as a metal lug cap.

The present invention overcomes challenges in the art by allowing the creation of a thin and lightweight preform having a finish with a thickness sufficient to withstand hot fill and pasteurization processes. The present two-step process also eliminates the problem of underpacking caused by prior art methods. Additionally, the thinner preform is able to cool faster, thus increasing the speed of manufacture. The present method also overcomes the difficulty of compromised axial and hoop stretch ratios; desired thickness of each the neck finish and preform can be achieved without having to alter the height or diameter of the preform body.

The method of the present invention is also more efficient than other proposed solutions. For example, there is no need to form two separate components, as in processes where a neck finish and preform are separately molded then mechanically attached. Thus, there is no waste of excess materials and no time lost on this extra step. Additionally, because the finish is molded onto the preform, problems associated with improper or inconsistent sizing between separate components are eliminated. This eliminates the possibility of an error occurring during the attachment step, and eliminates the potential for wasted product due to a failed attachment. The present method is also versatile, allowing the creation of the neck finish that can be used with a standard pre-made tubular body such a preform, or tailored to a tubular body having particular specifications.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A method of manufacturing an article, the method comprising:
providing a tubular body having a neck area;
positioning a finish mold on the neck area in a molding apparatus;
molding a molten plastic material between the neck area of the tubular body and the finish mold;
allowing the molten plastic material to solidify; and
removing the finish mold.

2. The method of claim 1, wherein the molding apparatus is an injection molding apparatus and the providing step comprises mounting the tubular body onto the injection molding apparatus.

3. The method of claim 1, wherein the finish mold comprises a thread split.

4. The method of claim 1, wherein the tubular body comprises a preform body.

5. The method of claim 1, wherein the tubular body comprises a container body.

6. The method of claim 1, wherein molding comprises injection or compression molding.

7. The method of claim 4, further comprising injection molding the preform body.

8. The method of claim 1, further comprising blow molding a container.

9. A method of manufacturing an article, the method comprising:
providing a molded tubular body having a neck area; and
molding a finish over the neck area.

10. The method of claim 9, wherein the tubular body and the finish are made from different materials.

11. The method of claim 9, wherein the finish comprises polyethylene terapthalate, polypropylene, polyethylene, polyethylene napthalate, process regrind, post consumer resin, or combinations thereof.

12. The method of claim 9, wherein the tubular body comprises polyethylene terapthalate, polyethylene terapthalate and ethylene vinyl alcohol, or polyethylene terapthalate and nylon.

13. The method of claim 9, wherein at least a portion of the tubular body is multilayered.

14. The method of claim 9, wherein the molded tubular body is an injection molded or compression molded preform body.

15. The method of claim 9, wherein the finish is injection or compression molded.

16. The method of claim 14, further comprising blow molding the preform body.

17. An article comprising a tubular body and a finish that is molded over the neck area of the preform body subsequent to molding of the tubular body.

18. The article of claim 17, wherein the tubular body and the finish are made of different materials.

19. The article of claim 17, wherein the at least a portion of the tubular body is multilayer.

20. The article of claim 17, wherein the article is a container.

21. The article of claim 17, wherein the article is a preform.
